(19) United States
(12) Patent Application Publication
(10) Pub. No.: US 2025/0098927 A1
(43) Pub. Date: Mar. 27, 2025

(54) FLOOR-TREATMENT APPARATUS COMPRISING A GUIDE PART WITH A JOINT ARRANGEMENT

(71) Applicant: I-MOP GMBH, Bensheim (DE)

(72) Inventor: Rudolf FRANKE, Bensheim (DE)

(73) Assignee: I-MOP GMBH, Bensheim (DE)

(21) Appl. No.: 18/832,372

(22) PCT Filed: Jan. 24, 2023
(86) PCT No.: PCT/EP2023/051655

§ 371 Date: Jul. 23, 2024

(30) Foreign Application Priority Data
Jan. 24, 2022 (DE) 10 2022 101 563.7

(51) Int. Cl. A47L 11/40; A47L 11/30; B25F 5/02

(52) U.S. Cl. CPC A47L 11/4075; A47L 11/30; B25F 5/02

(57) ABSTRACT

A floor treatment device is disclosed. The floor treatment device comprises a floor unit, a tool which contacts a floor surface in an operating state, a guide member for guiding the floor cleaning device by a user, and a joint assembly with at least two pivot axes, wherein the joint assembly is configured for pivoting the guide member relative to the floor unit about a first pivot axis and for pivoting the guide member relative to the floor unit about a second pivot axis, that is different than the first pivot axis relative to the floor unit. The floor treatment device further comprises a spring member for creating a spring force that optionally supports or counteracts a movement of the guide member relative to the floor unit when the guide member is pivoted about the first and/or second pivot axis relative to the floor unit.

Floor treatment device, preferably a floor cleaning device such as a scrub vacuum floor cleaning device

The present invention relates to a floor treatment device, preferably a floor cleaning device such as a scrub vacuum floor cleaning device. Such a floor treatment device according to the present invention comprises:
a floor unit;
at least a tool which is assigned to the floor unit and which contacts a floor surface in an operating state;
a guide member for guiding the floor cleaning device by a user;
a joint assembly with at least two pivot axes, wherein the joint assembly is configured to pivot the guide member relative to the floor unit about a first pivot axis and to pivot the guide member relative to the floor unit about a second pivot axis that is different than the first pivot axis relative to the floor unit.

A floor cleaning device is known from WO 2020/234904 A1. Thus, a coil spring surrounding a region of the guide member that connects the guide member and the floor unit is arranged between a guide member and the floor unit. The coil spring is firmly attached to the floor unit on one end and to the guide member on the other end. As a result, the spring force of the coil spring holds the guide member at an angle of approximately 90 degrees relative to the floor unit in a neutral position. If a user pivots the guide member out of the neutral position relative to the floor unit, the coil spring generates a counteracting restoring force in the direction of the neutral position. The restoring force increases with the size of the pivot angle relative to the neutral position.

If this floor cleaning device is put into operation and operated by a user, the user will realize that the neutral position of the guide member, that is realized via the coil spring, comes with substantial ergonomic disadvantages. If an operator's hands grasp the guide member in this neutral position, the operator's feet will collide with the floor unit. In turn, if the operator stands apart from the floor unit, the operator will have to extend the arms relatively wide to grasp the guide member in the neutral position. However, keeping the arms in this extended position is uncomfortable and a disadvantage in terms of ergonomics in the long run. Hence, an operator will pivot the guide member out of the neutral position towards their body during operation, meaning tilting or pulling it towards them to avoid having to hold the guide member with their arms extended. In this position, however, the operator must “work” against the restoring force generated by the coil spring and hold the guide member in a correspondingly deflected way so that the guide member does not return to its neutral position due to the restoring force of the coil spring. Depending on the strength of the restoring force caused by the coil spring, it may also be compensated to a greater or lesser extent with a torque about the pivot axis in the pivot direction that results from the weight of the guide member, at least in an angular range. However, the more an operator pivots the guide member, the more the operator will have to work against the restoring force so that pivoting to larger pivot angles is only possible with significant effort or not possible at all. In this regard, it has to be taken into account that when pivoting to larger pivot angles, a comparatively large reaction force is applied to the floor member via the at least one spring member. To be able to guarantee sufficient functionality, the floor member of this device has to be configured with comparatively heavy weight and/or a relatively big base surface. This makes the device heavy and bulky.

As another prior art document, reference is made to the granted European patent EP 3 031 378 B1, from which a floor cleaning device providing means for switching the device between an operating position and a space-saving transport or storage position as required is known. In the operating position, the guide member is freely pivotable relative to a floor unit. The guide member can thus be easily pivoted toward a user so that the latter can easily grasp the guide member. Pivoting freely further allows large pivot angles, which are particularly necessary to adopt the space-saving position. However, when freely pivoting the guide member, a rather significant portion of the guide member's weight rests upon the user or the user's arms during the entire pivot operation. This is not ergonomical.

In case of the floor cleaning devices known from prior art, an operator thus has to accept to carry a rather significant load on their arms and body when the guide member is pivoted relative to the floor unit. Furthermore, in the case of the floor cleaning device known from WO 2020/234904 A1, it will hardly be possible to completely, or at least almost completely, pivot the guide member about 90° relative to the floor unit into a position in which the floor cleaning device would have a low height because the restoring force increases inevitably as the pivot angle increases. Therefore, compact stowage or storage of the floor cleaning device or to use the floor cleaning device for cleaning underneath low projections is hardly possible.

In addition, in case of the device according to EP 3 031 378 B1, the user is not supported, or regarding the device according to WO 2020/234904 A1, supported in an unergonomic progressive way when pivoting the guide member relative to the floor unit sideways. In fact, when maneuvering a floor cleaning device, there are relative positions between guide member and floor unit that should be supported more by the spring force due to ergonomic reasons and other relative positions between guide member and floor unit that should be supported less by the spring force due to ergonomic reasons.

One object of the invention is to provide a floor cleaning device of the type described at the outset that overcomes at least one of the aforementioned disadvantages in view of the prior art. Furthermore, it is an object of the present invention to provide a floor cleaning device of the type described at the outset that enables a user to adopt a comfortable and ergonomic operating position and facilitates the entire operation of the device in an ergonomic way.

This object is achieved with a floor cleaning device of the type described at the outset, which is designed in such a way that at least a spring member for generating a spring force between the floor unit and the guide member is assigned to the joint assembly, wherein the spring force of the spring member optionally supports or counteracts a movement of the guide member relative to the floor unit when the guide member is pivoted about the first and/or second pivot axis relative to the floor unit.

According to one embodiment of the invention, it may be provided that the first pivot axis is substantially parallel to the floor surface. For example, the first pivot axis may be transverse to a forward direction of the device, in particular in an angle of 90° to the direction of advance.

Moreover, in this context according to one embodiment of the invention, it may be provided that the second pivot axis is transverse or skew to the first pivot axis. The two axes may intersect or may be disposed skewed at a distance in space to each other. They may be disposed in an imaginary vertical projection on the floor surface in an angle of 90° to each other.

A preferred embodiment of the invention provides that the joint assembly has a first pivot joint that defines the first pivot axis. According to this embodiment of the invention, specifically configured pivot joints with these respectively assigned pivot axes are provided. Thus, it is possible that the pivot axes of the relevant pivot joint are clearly defined, e. g. by the central axis of a pivot pin mounting the pivoting, or that they are virtual axes, e. g. in case of a pivot joint that is realized via an elastically deformable material or a spring and that, accordingly, has a clearly defined pivot axis. In the latter case, they are still called virtual pivot axes the position of which may change during pivoting. In this embodiment, the first pivot axis preferably extends parallel to the floor surface, in particular transverse to a direction of advance, in which the floor treatment device is moved in a forward direction.

Optionally, a spring member is assigned to only one or each of the pivot joints. Thus, a spring behavior for pivoting about the first and/or the second pivot axis may be defined in a targeted manner via the at least one spring member. For example, it will thus be possible to support pivoting about the first pivot axis in certain angular ranges of the swivel movement via the at least one spring member, however, pivoting in other angular ranges of the swivel movement about the first pivot axis may be counteracted and in further angular ranges, pivoting about the first pivot axis does not develop any spring action. The same applies with regard to pivoting about the second pivot axis, which is supported to a greater or lesser extent in predetermined angular ranges with regard to supporting or inhibiting the spring. In addition, the spring force supporting or counteracting pivoting may be constant or entirely variable, in particular, it may increase or decrease in a linear way, increase or decrease in a non-linear way. Additionally, it is possible that the spring force counteracting pivoting initially increases and then decreases or vice versa.

One embodiment of the invention provides that the first and/or second pivot joint has/have a neutral position. In such a neutral position, which may occur selectively at a certain swivel angle or at a certain angular swivel range, the spring member may not develop any spring force at all or it may keep the guide member in the respective neutral position through the spring force applied by guide member opposite the floor unit. In other words, this means that at least one spring member absorbs the weight force applied on the guide member in this neutral position and thus relieves the user.

One embodiment of the invention provides in this context that in the neutral position of the first pivot joint, the guide member relative to the floor unit is disposed about the first pivot axis in such a way that the longitudinal axis of the guide member with a vertical axis extending perpendicular to the floor surface and perpendicular to the first pivot joint comprises an angle that ranges between 0° and 60°, preferably in a range between 15° and 45° and most preferably at approximately 30°. Such a neutral position of the guide member relative to the floor unit regarding the first pivot axis allows the user to grip the guide member without much effort and to hold and effortless guide it in this position while using the floor treatment device. The guide member is opposite the forward-oriented machining direction and direction of movement on the ground and is thus tilted towards the user in the intended angular range in an ergonomic way.

Moreover, one embodiment of the floor treatment device according to the invention provides that in the neutral position of the second pivot joint the guide member relative to the floor unit is disposed about the second pivot axis in such a way that the longitudinal axis of the guide member with the first pivot axis includes an angle of approximately 90°. That means that the guide member is kept in a neutral position with regard to the second pivot axis so that it is neither noticeably pivoted to one nor the other side of the floor treatment device. In a manner of speaking, it is substantially held above the ground in central alignment. However, using the neutral position as a starting point, the user may pivot the guide member relatively easy sideways. Thus, without effort for the user, it is possible to move the floor treatment device straight ahead.

According to one embodiment of the present invention, it is provided that at least a spring member keeps the guide member in the neutral position with regard to the first and/or the second pivot axis via the spring force in a certain angular position or a predetermined angular range. In other words, the at least one spring member is configured or disposed in such a way that the user has to use a predetermined effort for an intended swivel movement of the guide member starting from the respective neutral position regarding the first and/or the second pivot axis to be able to carry out the swivel movement. On the other hand, the user may expect that if the guide member is pivoted into the direction of the neutral position or into the neutral position regarding the first and/or the second pivot axis, the guide member glides into the respective neutral position through spring force support and is reliably held in this position when reaching the neutral position. In other words, this means that according to an embodiment of the invention when pivoting the guide member relative to the floor unit out of the neutral position regarding the first and/or the second pivot axis into at least one pivot direction of at least one spring member, a spring force, which initially increases via a first angular range regarding the first and/or the second pivot axis to a force threshold value, wherein the user experiences a significant relieve of not having to hold or not having to hold the entire weight force of the pivoted guide member and remains either constant or decreases when exceeding the first angular range by overcoming the force threshold value due to further pivoting. This helps to achieve that, for example in the case of especially heavy floor treatment device the floor unit remains relatively unaffected by the extent of the pivoting and thus is easy to maneuver.

It is to be noted that for example only one spring member regarding the pivot axis may be provided and that in addition to another spring member, or alternatively to this, a mechanical support, may be provided. Such a mechanical support may for example be achieved by a lever, which may be folded into a support position and which may be folded back into an at-rest position. In a manner of speaking, a mechanical stopper that may be activated as required may be provided that defines the neutral position regarding the respective pivot axis.

In addition, it is to be noted that in practice, when the guide member relative to the floor unit is in the neutral position, either due to support of the at least one spring member or due to mechanical support, the user may just release the guide member without it tilting about the respective pivot axis or even dropping to the floor. Thus, a user, may for example, take a short break without having to set the floor treatment device according to the invention to a specific mode. Subsequently, the user may immediately continue with the task. This may be called “stop and go” operation. Thus, unimanual operation is easily possible, so that the user may for example only has to burden one arm. The user may then continue with treating the floor but may let go of the guide member for a short distance to briefly relax. By holding the guide member in the neutral position about the respective pivot axis, the floor treatment device then continues to move in the direction of advance on its own, where applicable, it is powered in the direction of advance by the rotation of the tool or the tools or just by the remaining momentum. In such a situation, the user only has to follow the floor treatment device and may briefly relax. Subsequently, the user may grip the guide member again and continue to maneuver the floor treatment device. This contributes substantially to the ergonomics of the floor treatment device according to the invention.

Regarding the characteristics of the at least one spring member, it may be provided according to the invention that the spring force of the at least one spring member is substantially constant while pivoting the guide member relative to the floor unit about the first or about the second pivot axis. Alternatively, it may be equally possible according to the invention that the spring force of the at least one spring member is substantially variable, preferably variable in a non-linear way, while pivoting the guide member relative to the floor unit about the first or about the second pivot axis. In this context, it may be determined that according to the present invention, it is possible that at least a spring member is assigned to the first pivot joint that corresponds to the spring characteristics of at least one spring member that is assigned to the second pivot joint or that the spring characteristics of the spring members assigned to the two pivot joints differ from each other.

In case of a simple and budget-friendly variation of the present invention, it is provided that a single, shared spring member is assigned to the first und second pivot axis. However, it should be noted that in deviation from prior art, clearly defined first and second pivot joints are provided according to document WO 2020/234904 A1, which are spring-loaded via the only spring member. Such a spring member may, for example, comprise a coil spring. For example, the spring member may also be a tension spring or compression spring that has the same effect or a different effect regarding each of the joint axes via one of these associated mechanics, such as a leverage, a gearbox or a cable pull when it is pivoted about joint axes.

As an alternative to this, it may be provided in a preferred variant of the invention that at least a separate spring member is assigned to each of the first and second pivot axes. This makes it possible to achieve suitable spring characteristics adapted specifically to every pivot joint while taking the preferred angular swivel ranges into account. Thus, as already indicated above, it is possible that the spring members have the same or different spring characteristics. Thus, it may be achieved to pivot the guide member with more or less noticeable support felt by the user based on the respective pivot joint and while taking the preferred angular swivel range into account. Moreover, it also has to be taken into account in this context that the guide member often comprises at least a liquid tank, for example for fresh water or used water so that the support may change depending on the liquid level of the liquid tank.

In connection with different spring members or spring characteristics it may be provided in particular that the spring force of the spring member that is associable to pivot the guide member relative to the floor unit in a forward or backward direction is configured to generate a larger support or counteracting effect, in particular spring force, than the spring member that is associable to pivot the guide member relative to the floor unit in a lateral direction. It may be provided in particular that the spring member that is associable to pivot about the first pivot axis is configured to provide a larger support or counteracting effect, in particular spring member, than the spring member that is associable to pivot about the second pivot axis. In this context, the spring member mentioned first may, for example, have a bigger spring constant than the spring member mentioned second.

Additionally or alternatively, it may be provided that the spring member generates a larger support or counteracting effect, in particular spring force, when it is pivoted in a backward direction than when it is pivoted in a forward direction, in particular starting from the neutral position and/or a middle position. Middle position and/or neutral position may mean that the guide member or a longitudinal axis of the guide member is substantially perpendicular to the floor surface. Moreover, it may be provided, for example, that when pivoting in a forward direction, at least from a predetermined swivel angle onwards, in particular from the neutral position onwards, it is decoupled in such a way that the spring member substantially does no longer support or counteract the movement of the guide member relative to the floor unit. During operation of the floor treatment device, the operator may often pivot the guide member in a backward direction or, starting from the neutral position or middle position, a back area. In contrast, starting from the neutral position or the middle position, pivoting in a forward direction is rather uncommon. Thus, it is especially beneficial for ease of use if the spring member generates a larger supportive or counteracting effect when starting from the neutral position or the middle position in a backward direction when it is pivoted than starting from the neutral position or the middle position when it is pivoted in a forward direction. According to an embodiment, it may be provided that the spring member does substantially not generate any support or counteracting effect, in particular no spring force, when it is pivoted in a forward direction, especially starting from the neutral position. Such an embodiment is particularly useful if a pivot movement starting from the neutral position or the middle position in a forward direction would lead to undesired tilting of the floor unit due to the spring force used.

According to a variant of the invention that has a sturdy construction and that may be easily manufactured, it is provided that the spring member has at least a profile body with a slide section as well as a spring element. Thus, the slide section may determine the amount of non-linear variable spring force in interaction with the spring action of the spring element when pivoting the guide member via the second pivot joint about the second pivot axis relative to the floor unit, in particular depending on the current angular position between the guide member and the floor unit. The profile body may be configured differently and has a contour surface or contour path defining the slide section. Depending on the design of this contour surface defining the slide section, this may then provide the spring effect characteristics of the spring member.

Thus, it might be provided, for example, that the at least one profile body is attached to the guide member and is pivotable about the first and/or second pivot axis with the guide member.

As an alternative to this, it is possible according to another variant of the invention that the at least one profile body is attached directly or indirectly to the floor unit in such a way that it is not pivoted or moved when the guide member is pivoted about the first or second pivot axis relative to the floor unit opposite the guide member.

According to a variant of the invention deviating from this, it is also possible that the at least one profile body is attached directly or indirectly to the joint assembly in such a way that it is not pivoted or moved when the guide member is pivoted about the first or second pivot axis relative to the floor unit opposite the guide member, however, it is pivoted with the joint assembly when the guide member is pivoted about the first pivot axis relative to the floor unit. In case of this embodiment, the profile body may be attached, for example, to a joint body of the joint assembly disposed between the first and the second pivot joint.

Depending on the desired spring characteristics, it may be provided that the at least one profile body has a concave or convex, preferably a double convex slide section or a slide section formed of concave and convex sections. By selecting a respective suitable geometry of the slide section, the desired spring characteristics and thus a support or inhibition effect to a greater or lesser extent may be achieved along a swivel movement of the guide member relative to the floor unit about the respective pivot axis. Thus, depending on the slide section, it is possible to provide angular ranges with more support in the sections that are supported less by the spring member, among other things. There are, for example, preferred pivot positions about the second pivot axis—in addition to the neutral position—in which the guide member is to be held entirely or nearly entirely by the spring force of the spring member. Thus, the user may pivot the guide member laterally to the floor unit without having to hold the weight force in case of the present invention when pivoting without spring support as the weight force is supported by the spring member.

It is further possible to equip certain areas with more or less spring resistance, so that the user has to use additional force with certain pivot movements.

For example, it may be provided in an embodiment that the concave slide section has a substantially central apex region for defining the neutral position. Thus, the slide section may be configured in the shape of a more or less open parabola.

Alternatively, it may be provided in this regard that the double convex slide section has two concave slide section segments, which are connected by a substantially central concave connecting area to define the neutral position. The interlock may be achieved in an easy and effective way via the central concave connecting area. The convex slide section segments adjacent to the central concave connecting area cause the above-mentioned increase in force when pivoting out of the neutral position up to a force threshold value after which any further pivoting may be supported by spring force.

Regarding the constructional embodiment and an ergonomic as well as a low-wear operation, one embodiment of the invention provides that at least a rolling element or slide element concurring with the slide section is assigned to the spring member, wherein the rolling element or slide element is biased onto the slide section via the spring element and rolls or slides on the slide section when the guide member is pivoted relative to the floor unit about the first and/or second pivot axis.

It may further be provided that according to the invention, the spring member comprises a compression spring, a tension spring or a spring-damper member.

Moreover, according to the invention, it is possible that the at least one spring member may be activated and deactivated. Thus, the spring member may be blocked completely, for example using a lever mechanism and/or a lock mechanism, so that it does not carry out any spring force when pivoting the guide member relative to the floor unit. In general, due to the fact that it may be activated or deactivated, the user may “deactivate” the spring support completely in certain operating situations and use the spring support of the floor treatment device in other operating situations, if necessary. A kind of rigid cage may be used as lock mechanism that may be pulled over the spring member if necessary, in particular foldable, and blocks a compression or elongation of the spring member. In connection with the fact that it may be activated or deactivated, it may be further provided that the spring member is coupled pivotably with the guide member or the floor unit. Thus, a first pivoting position may be provided, in which the spring member is configured to create the spring force and a second pivoting position, in which the spring member is not configured to create a spring force, may be provided. Thus, it may be provided that the spring member is engaged or engageable with the guide member and/or the floor unit in the first pivoting position while it is not engaged or engageable with the guide member and/or the floor unit in the second pivoting position. Instead or in addition to the pivotability of the spring member, a pivot lever may be provided, which is disposed in its first pivoting position on the floor treatment device in such a way that the spring member is configured to generate spring force when pivoting the guide member relative to the floor unit and which is disposed on the floor treatment device in such a way in its second pivoting position that the spring member is not configured to generate spring force when pivoting the guide member relative to the floor unit. It may further be provided that the pivotability of the spring member or the pivot lever between the activated and the deactivated position in the neutral position and/or from a predetermined swivel angle in the forward direction, starting from the neutral position, is provided.

An embodiment of the invention provides that the at least one spring member is adjustable, meaning that the user may bias it to a greater or lesser extent depending on the user preferences, so that the support effect of the at least one spring member may be adjusted. This may be an advantage if, for example, a user prefers to always carry a certain share of the weight force of the guide member to control the floor treatment device more directly. A setting may also be based on the filling level of the liquid tank for fresh water and used water provided at the guide member. The setting may be carried out manually, for example via a setting nut in combination with a screwed pressure spring or electromechanical, where applicable even automated via an electromechanical or electromagnetic actuator.

According to an embodiment it may be provided that the joint assembly is lockable, in particular regarding pivoting about the first and/or second pivot axis, so that pivoting may be prevented at least temporarily. Such a lockability may be provided for predetermined swivel angles. In addition, it may be provided that the joint assembly is lockable about the first and/or second pivot axis for any swivel angles or within predetermined angular swivel ranges.

According to an embodiment of the invention, the floor treatment device may be configured for wet cleaning the floor surface. Thus, a particularly good cleaning result may be achieved.

In one example it may be provided that the floor cleaning device is configured to at least apply liquid at phases, such as for example fresh water or cleaning fluid, onto the floor surface. This liquid may be provided in a fresh water container, which is preferably provided at the guide member of the floor treatment device.

In one example, the floor treatment device may comprise a waste water container to collect dirty water removed or vacuumed from the floor surface.

In one example, the floor treatment device may comprise a vacuum turbine for vacuuming liquid from the floor surface. The vacuum turbine may be configured to create a negative pressure in the waste water container. It may be provided that liquid may be pumped from the floor surface into the waste water container in particular via a vacuum hose using negative pressure.

In one example, the floor treatment device may comprise a vacuum bar that is provided to collect liquid on the floor and/or remove it from the floor surface and/or absorb and/or vacuum it. In particular in connection with the vacuum turbine, it may be provided that, starting from the vacuum bar, it vacuums the liquid and transports it into the wase water container.

In one embodiment of the invention, the floor treatment device may be configured in an operative state to provide an advance effect, in particular an advance force, in the direction of advance. This advance effect may, at least partly, be provided by moving at least one of the tools relative to the floor surface.

In one embodiment of the invention, the floor treatment device may be battery powered or powered by batteries. Thus, the floor treatment device may comprise a battery configured to provide electrical energy to operate the floor treatment device.

In the following, embodiments of the invention are described by way of example with reference to the figures. In the drawings:

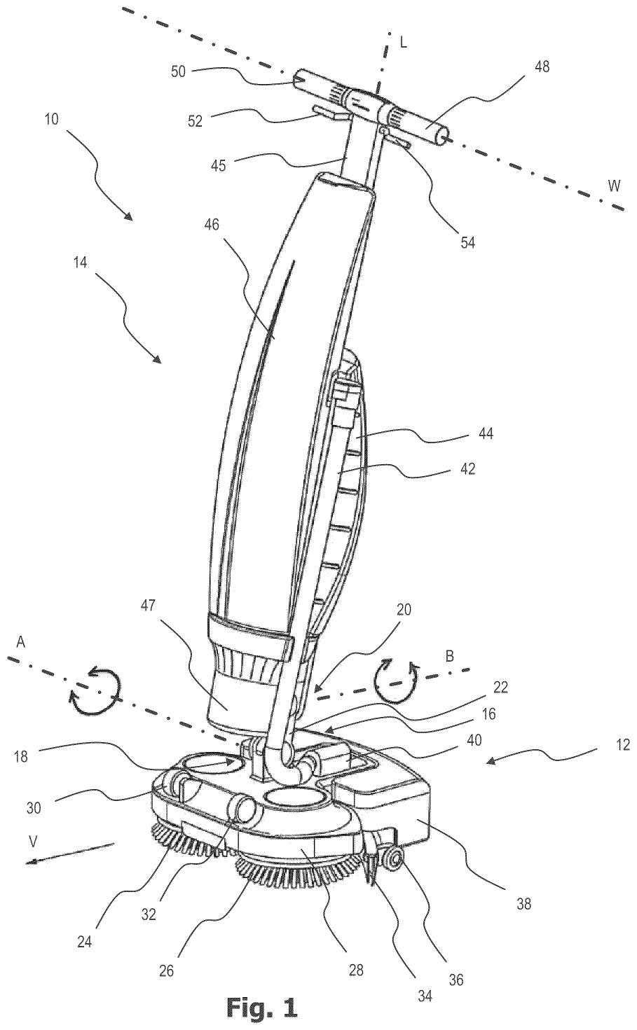

FIG. 1 is a spatial representation of an embodiment of a floor cleaning device according to the invention;

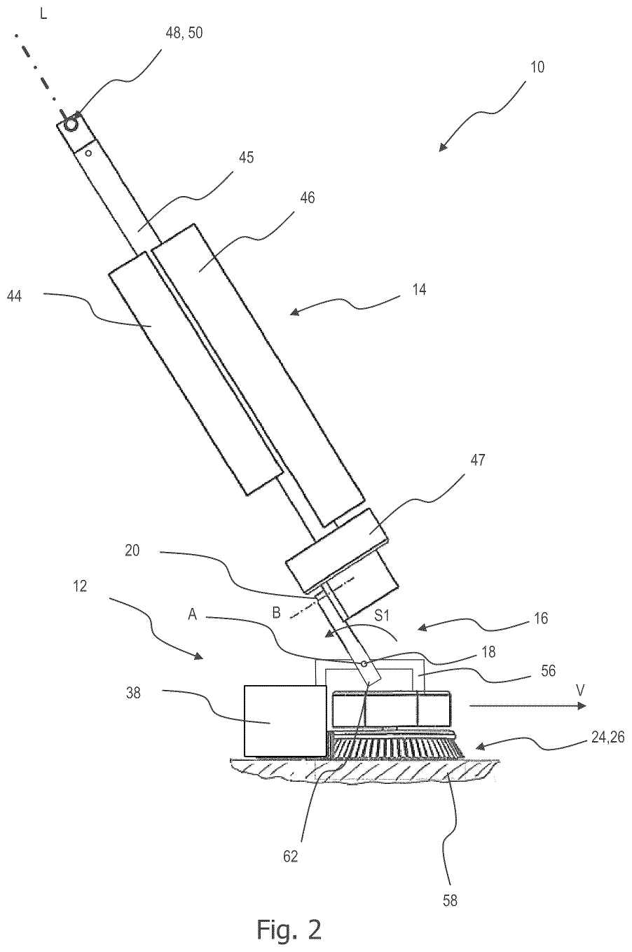

FIG. 2 is a schematic representation of a side view of the embodiment of the floor cleaning device according to the invention in accordance with FIG. 1;

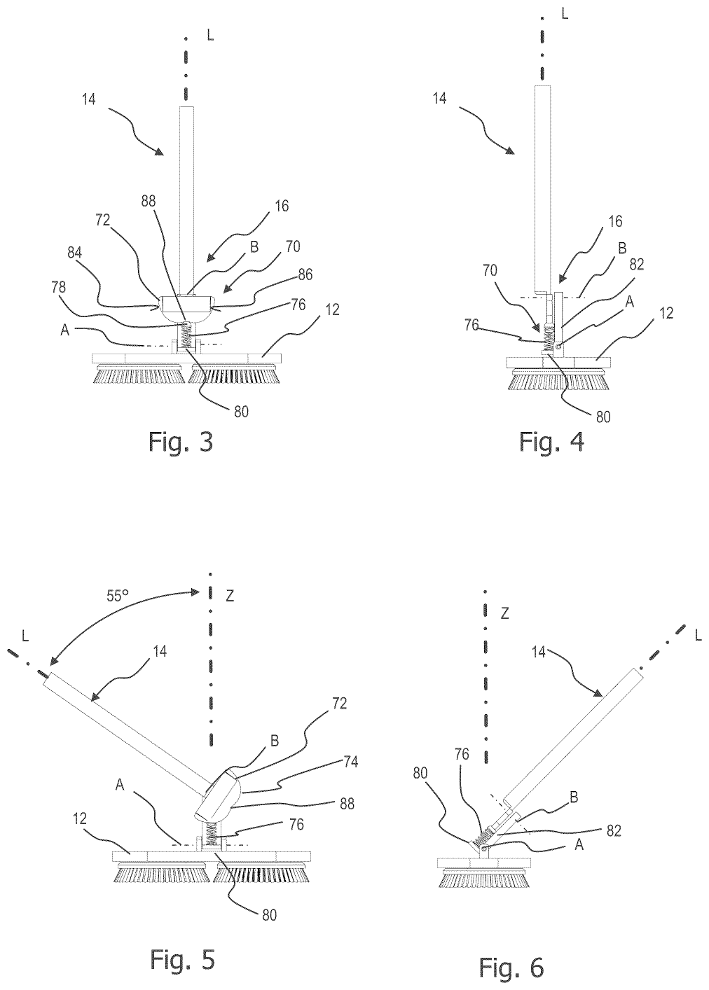

FIG. 3-6 are schematic representations of a floor cleaning device comprising a spring member for support in certain areas or for inhibiting pivoting of the guide member about the second pivot axis;

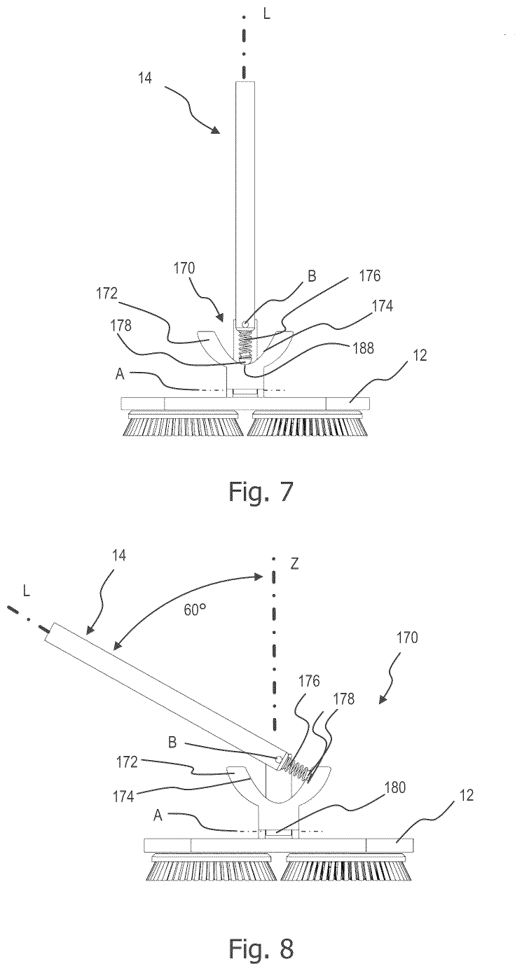

FIGS. 7 and 8 are schematic representations of a floor cleaning device comprising an alternatively configured spring member for support in certain areas or for inhibiting pivoting of the guide member about the second pivot axis;

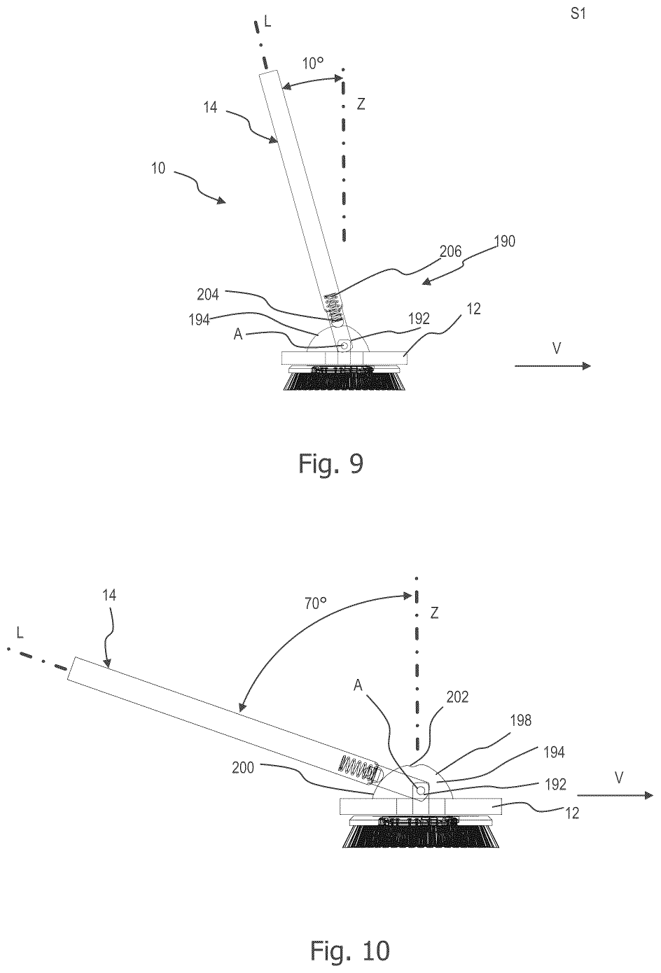

FIGS. 9 to 11 are schematic representations of a floor cleaning device comprising one spring member for support in certain areas or for inhibiting pivoting of the guide member about the second pivot axis;

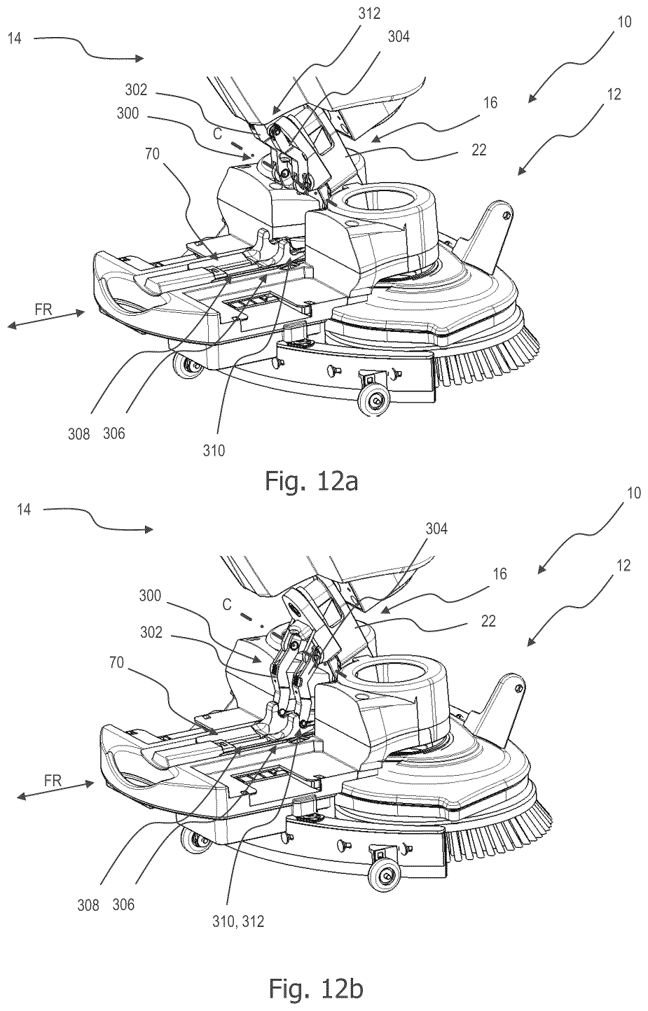

FIGS. 12a and 12b are detailed schematic representations of a floor cleaning device comprising a spring member according to one implementation;

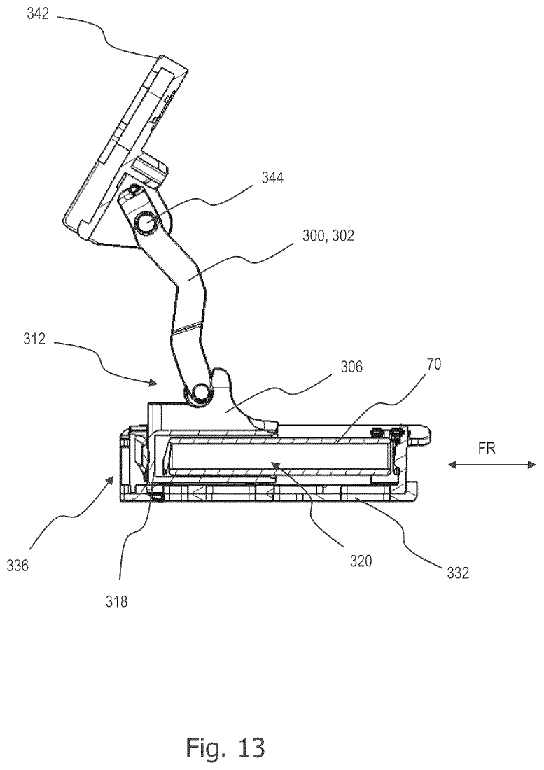

FIG. 13 is a schematic cross-sectional view comprising the spring member according to the implementation of FIGS. 12a and 12b; and

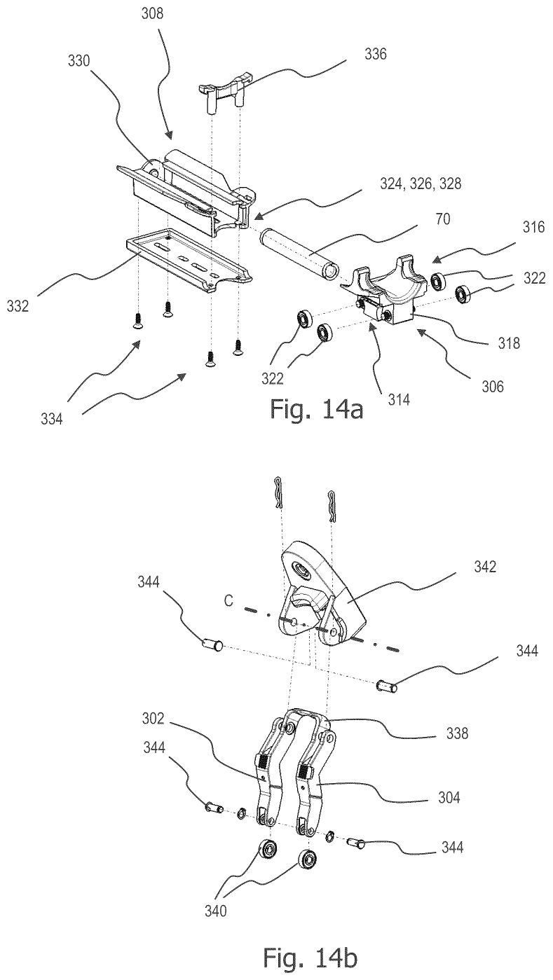

FIGS. 14a and 14b are schematic exploded views of an assembly of the floor cleaning device comprising the spring member according to FIGS. 12, 12b and 13.

FIG. 1 is a spatial representation of an embodiment of the floor cleaning device 10 according to the invention. It comprises a floor unit 12 and a guide member 14 which are connected to one another in an articulate manner via a joint assembly 16.

A joint assembly 16 comprises a first pivot joint 18 enabling the guide member 14 to pivot relative to the floor unit 12 about a first pivot axis A. The joint assembly 16 further comprises a second pivot joint 20 enabling the guide member 14 to pivot relative to the floor unit 12 about a second pivot axis B. The first pivot axis A and the second pivot axis B are arranged at a distance from and orthogonally to one another on a connecting member 22 of the joint assembly 16 connecting the first pivot joint 18 to the second pivot joint 20.

Two brush-type tools 24, 26 are assigned to the floor unit 12. They protrude from a floor unit housing 28 in the direction of a floor surface and are also driven by a drive device arranged in the floor unit housing 28 and not shown in further detail. The tools 24, 26 are inclined relative to a floor surface in such a way that, in an operating state of the floor cleaning device 10, the rotation of the tools 24, 26 produces an advance effect in a direction of advance V. Two spaced transport rollers 30, 32 are arranged on a front, upper side of the floor unit housing 28. Furthermore, a vacuum bar 34 is arranged on the floor unit housing 28 as a component of a vacuum unit extending in an arc behind the floor unit housing 28 and at least partially enclosing it. Several support wheels 36 are arranged on the vacuum bar 34, of which only one is visible in the view shown in FIG. 1 and the second one and potentially more is/are covered by the floor unit 12. Furthermore, a container 38 serving as a receptacle for a battery supplying power to the floor cleaning device 10 is attached to the floor unit 28. Moreover, a hose connection member 40 to which a vacuum hose 42 of the vacuum unit is coupled is configured on the upper side of the floor unit 12.

At its other end, the vacuum hose 42 is coupled to a waste water container 44, which is preferably removably arranged on a shaft 45 of the guide member 14. Dirty water picked up by the vacuum bar 34 from the floor surface or a cleaning surface not shown may thus be conveyed into the waste water container 44 via the vacuum hose 42. The waste water container 44 is detachably coupled to the shaft 45.

A fresh water container 46 is further configured on the shaft 45 on a side of the shaft 45 opposite the waste water container 44. Thus, fresh water may be supplied to the floor unit 12 by a fresh water line not shown in detail and the fresh water may be applied to the floor surface in the area of the tools 24, 26. Fresh water is a liquid intended for cleaning. It need not necessarily be pure water. It may also be a cleaning agent or water with an added cleaning agent or an added cleaning substance.

A vacuum turbine 47 of the vacuum unit, which is coupled to the waste water container 44 and generates a negative pressure in the waste water container 44 to suck in the dirty water, is configured on the shaft 45 below the waste water container 44 and the fresh water container 46.

The guide member 14 or the shaft 45 has a longitudinal axis L that is perpendicular to the second pivot axis B. As shown in FIG. 1, the second pivot joint 20 is not deflected about the second pivot axis B so that the longitudinal axis L is perpendicular to the first pivot axis A as well. In this position, the guide member 14 assumes a neutral position about the second pivot axis B relative to floor unit 12.

Handles 48, 50 that have a round ergonomic shape and extend along a handle axis G, which is orthogonal to the longitudinal axis L, are arranged at a top end of the shaft 45. In the present case, the handle axis G is parallel to the first pivot axis A as well. Actuating members 52, 54 are also configured on the shaft 45 below the handles 48, 50. Functions of the floor cleaning device 10, such as the propulsion speed, speed of the tools, characteristics of the fresh water application to the floor surface and more of the like may be activated or deactivated using the actuating members 52, 54.

The arrangement of spring members regarding the first and second pivot axis may not yet be seen in FIG. 1 in its details. This will be discussed in more detail in connection with the following figures.

FIG. 2 is a schematic side view of the embodiment of the floor cleaning device 10 according to the invention when looking right in the direction of advance V. Compared to FIG. 1, the floor cleaning device 10 is simplified and shown only schematically.

In this regard, it also shows the shaft 45 of the guide member 14, to which the fresh water container 46, the waste water container 44 and the vacuum turbine 47 are attached. In addition, the handles 48, 50 are arranged at the top end of the shaft 45.

The guide member 14 is coupled to the floor unit 12 through the joint assembly 16. More precisely, the guide member 14 is coupled to the second pivot joint 20 of the joint assembly 16. Further, a support bracket 56 coupling the joint assembly 16 or the first pivot joint 18 to the floor unit housing 28 of the floor unit 12 is configured on the floor unit 12. This type of attachment, however, is due to the schematic representation and could also be solved by directly attaching the first pivot joint 18 to the floor unit without a support bracket 18 as known from FIG. 1.

The brush-type tools 24, 126 contacting a floor surface 58 that is to be cleaned are arranged on the floor unit 12. Furthermore, the receptacle 38 of the floor unit 12 is recognizable.

After the basics of the floor cleaning device 10 were described above, it will be explained in more detail below in FIGS. 3-11 how the guide member 14 opposite the floor unit 12 may be supported via one or several spring members. These representations are schematic and do not show all the details shown in FIGS. 1 and 2.

In one embodiment of the invention, as shown schematically in FIGS. 3 to 6, the guide member 14 opposite the floor unit 12 is pivotable about the second pivot axis B of the joint assembly 16, wherein this pivoting is applied with a spring force of the spring member 70. The spring member 70 comprises a profile body 72 with a slide section 74. The profile body 72 is firmly connected with the guide member 14 and is pivoted together with it about the second pivot axis B. The spring member further comprises a screwed pressure spring 76 as well as a spherical unwinding body 78, which unwinds on the slide section 74 of the profile body 72 when pivoting the guide member 14 relative to the floor unit 12.

The screwed pressure spring 76 is supported by a support 80. This support 80 is configured at an angular element 82, which supports and guides the screwed pressure spring 76 along its length and during compression. The angular element 82 is part of the joint assembly 16. It is pivotably supported about the first pivot axis A at the floor unit 12.

It is noted at this point that a spring member may be assigned to the first pivot axis A as well, which is not shown in the simplified representation of FIGS. 3-6. This will be discussed with regard to FIGS. 9-11 and the description of the implementation shown therein. It is emphasized that the respective spring members may be combined in a joint embodiment, so that a swivel movement about the first pivot axis A as well as a swivel movement about the second pivot axis B may be applied with a spring force by a spring member.

If one now focuses on the embodiment according to FIGS. 3 to 6 again, it is noticeable that FIGS. 3 and 5 are configured with a double convex slide section 74 and have a concave immediate area 88; in other words, they are formed like a round curved Latin letter “W” or the Greek letter “ω”. Accordingly, the slide section 74 in this embodiment has two convex sections 84, 86 that are connected by a harmoniously curved concave section 88. The concave section 88 defines the neutral position regarding the pivot movement about the second pivot axis B. The neutral position is shown in FIG. 3 as well as in FIG. 4. The slide section 74 is configured and disposed in such an interaction with the spring element 76 and the unwinding body 78 that it keeps the guide member 14 relative to the floor unit 12 in the neutral position shown in FIGS. 3 and 4, wherein the unwinding body 78 is pressed into the concave section 88 in the sense of an interlock via the screwed pressure spring 76. If the guide member 14 is to be moved out of the neutral position shown in FIG. 3 and pivoted, it is necessary to overcome a force threshold value that is predetermined by the convex sections 84 or 86 adjacent to the concave section 88 and their geometry.

The two convex sections 84 and 86 are configured in such a way that the screwed pressure spring 76 is initially increasingly progressively compressed when a movement out of the neutral position according to FIG. 3 is made until approximately a deflection of the longitudinal axis of the guide member L is made out of the neutral position by approximately +/−10°. This may be different depending on the design of slide section 74. After reaching this angular position, further deflection of the screwed pressure spring 76 is only compressed with a lower rate as a result. In FIG. 5, for example, a deflection of the guide member 12 with its longitudinal axis of the guide member L opposite the neutral position is shown to be 55° according to FIG. 3. It can be seen that the screwed pressure spring 76 is more compressed in this position. This means that the spring member 70 supports the guide member 14 more in this position and relieves the user, who holds the guide member 14 as a result of the pivot movement, when taking up the weight force of the guide member corresponding to the compression of the screwed pressure spring 76. Depending on the design of the slide section 74 with a wider or less wide path, the force characteristics of the spring member 70 may be changed. In the present case, the position shown in FIGS. 5 and 6 provides a lot of supports for the spring member 70.

If the user moves the guide member 14 out of the position shown in FIG. 5 back into the neutral position shown in FIG. 3, they are supported by the spring member 70. During the pivoting movement, the unwinding body 78 unwinds with low friction and low wear on the slide section 74.

If one now takes the alternative embodiments according to FIGS. 7 and 8 into account, it is noticeable that in case of this embodiment, a slide section 174 is secured to the angular element 82. The screwed pressure spring 176 with a corresponding unwinding body 178 is however firmly secured to the guide member 14 and mounted on it. FIG. 7 shows the neutral position, FIG. 8 shows a position, in which the guide member 14 opposite the floor unit 12 is pivoted with an angle relative to the vertical line Z by approximately 60° to the left.

While the spring element 176 is substantially configured identically in this embodiment, as described and shown therein with reference to FIGS. 3-6, only reversed with the unwinding body 178 acting downwards and supported at the guide member 14, so that the spring element 176 is compressed along the longitudinal axis of the guide member L and is able to unbend, the profile body 172 with its slide section 174 may be designed completely different in this embodiment than in the embodiment according to FIGS. 3-6. The slide section 174 is configured as a concave surface, which substantially forms a parabola. In the center, an apex 186 is provided that defines the neutral position according to FIG. 7. The parabolic slide section 174 is configured in such a way that the spring element 176 is unbend as much as possible in the neutral position shown in FIG. 7, however, it is still under tension and thus causes the guide member 14 to remain in the neutral position without exerting any external force.

If the spring element 176 is pivoted to the left or to the right out of the neutral position, it is increasingly compressed while the unwinding body 178 is unwound onto the slide section 174, so that with increasing deflection, the guide member 14 is supported more by the spring element 176. The user who pivots the guide member 14 thus experiences increasing support with increasing deflection, so that the weight force of the guide member, which has to be increasingly adopted by the user with increasing pivoting, may be at least partly supported via the spring element 176. Depending on the embodiment of the slide section 174, meaning depending on the course of the parabola, a characteristic line of the spring force that is more or less progressive may be achieved.

If the guide member 14 is moved back from the position shown in FIG. 8 to the neutral position shown in FIG. 7, the spring element 176 unbends. In the neutral position, the unwinding body 178 is located approximately at the apex 186 of the parabola.

FIGS. 9-11 show how a respective spring member 190 that supports pivoting about the first pivot axis A and applies a spring force to it may be configured.

In turn, the only schematically shown basic components, such as the floor unit 12 and the guide member 14, are visible in these figures. A schematically shown bearing fork 192, that defines the first pivot axis A via a bearing pin, is secured to the floor unit 12. A profile body 194 with a slide section 196 that has two convex portions 198, 200 that are interrupted by the concave portion 202, is secured to the floor unit 12. The individual sections 198, 200, 202 substantially merge into each other. The concave section 202 defines the neutral position shown in FIG. 9. In this neutral position, the longitudinal axis of the guide member L is tilted backwards by approximately 10° contrary to the direction of advance V opposite a vertical line Z perpendicular on the first pivot axis A, which means, that the guide member 14 is tilted towards the user standing behind the floor cleaning device 10. Again, this neutral position according to FIG. 9 is achieved by interlocking the spring member 190, meaning that the unwinding body 204 is pressed into the concave portion 202 via the screwed pressure spring 206.

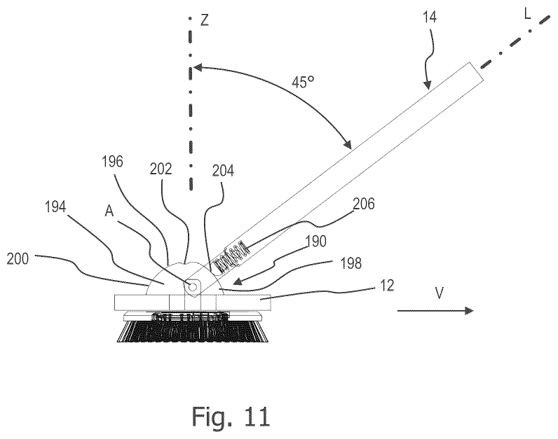

If the user moves the guide member 14 out of the catch position or neutral position shown in FIG. 9 backwards about the first pivot axis A, contrary to the direction of advance V, as shown in FIG. 10, or forward in the direction of the direction of advance, as shown in FIG. 11, the unwinding body 204 unwinds on the profile body 194 under compression of the screwed pressure spring 206. The screwed pressure spring 206 is thus compressed depending on the contour of the convex portions. In this regard, it has to be mentioned that in the implementation shown, the compression of the screwed pressure spring 206 is significantly stronger when pivoted backwards according to FIG. 10 and with a higher degree of compression with increasing pivoting out of the neutral position according to FIG. 9 in the direction of the position according to FIG. 10 than when pivoted forward out of the neutral position according to FIG. 9 in the direction of the position according to FIG. 11. Thus, it may be achieved that the user is relieved with increasing pivoting backwards and the weight force of the guide member 14 does not have to be carried or only carried in part.

As already explained above, the variations of spring support for pivoting a guide member 14 about the second pivot axis B shown in FIGS. 3 to 6 or 7 and 8 may be combined with the variation shown in FIGS. 7 to 11 so that one floor cleaning device may be pivoted about the first pivot axis A as well as about the second pivot axis B with spring support of one of the spring members 70 or 170 as well as 190 respectively. The person skilled in the art is able to carry out the constructional integration of two spring members into the entire joint assembly 16. It can be seen, for example, that in the embodiment according to FIG. 1, the assembly may be secured without further ado directly at the floor unit 12 according to FIGS. 9-11 and that the assembly according to FIGS. 3-6 may be secured to the guide member 14 without further ado.

FIGS. 12a and 12b relate to detailed schematic representations of a floor cleaning device 10 according to an implementation. The floor cleaning device 10 comprises the spring member 70 disposed on the floor unit 12. The floor cleaning device 10 further comprises a pivot lever assembly 300 that is disposed in a deactivated position in FIG. 12a and in an activated position in FIG. 12b. The pivot lever assembly 300 has two pivot lever arms 302, 304, wherein, however, only one pivot lever arm may be provided as well. Instead of a substantially rigid pivot lever arm, a shock absorber assembly may be provided as well, which is configured to dampen changes in the swivel angle. The pivot lever assembly 300 is articulated and is pivotable about a third pivot axis C with the guide member 14 or is coupled with the connecting member 22 of the joint assembly 16, as in the present case.

A guide slide 306 is disposed at the floor unit 12, which is disposed displaceably relative to a guide rail 308 along a guide direction FR. The guide direction FR is located on a joint plane together with the second pivot axis B and is aligned perpendicular to the first pivot axis A. The guide slide 306 has two elevations that are configured upwards, which form a concave receiving area 310 for contacting the pivot lever assembly 300. More specifically, the pivot lever assembly 300 has a free end 312, which is disposed at the connecting member 22 of the joint assembly 16 articulately secured to end of the pivot lever assembly 300 on the other side. In the activated position of the pivot lever assembly 300, a respective pivot lever arm 302, 304 is configured to contact a respective elevation depending on the pivot movement of the guide member 14 relative to the floor unit 12.

As it is shown in at least FIGS. 13 and 14a, the spring member 70 is configured as a compression spring, which is accommodated in a recess of the tub-shaped guide rail 308. In this regard, the spring member 70 is oriented in such a way that its spring force acts in the guide direction FR when the spring member 70 is actuated. The guide slide 306 has a first guide protrusion 314 and a second guide protrusion 316, which respectively form one of the elevations to contact the pivot lever assembly 300. The guide slide 306 further has a central area 318 disposed within the guide rail 308, wherein the central area 318 has a receptacle opening 320 open at the back to accommodate the spring member 70 at least partially. On the two lateral sides of the central area 318, two castors 322 are disposed respectively, which are coupled rotatably with the central area 318 around the axis perpendicular to the guide direction FR. The castors 322 are configured to roll off in the respective guide openings 324, 326 of the guide rail 308 that are configured within the guide rail 308 and extend parallel towards the guide direction FR to shift the guide slide 306 relative to the guide rail 308. The guide rail 308 has an opening 328 on its front side to accommodate the spring member 70 and the guide slide 306. This means that the tub shape is interrupted. The guide rail 308 is also closed on its back side and has a support wall 330. In the assembled condition, one end of the spring member 70 engages at the support wall 330 and the other end of the spring member 70 engages with the receptacle opening 320 und thus at the central area 318 of the guide slide 306, wherein the spring member 70 applies a compressive force on both of its ends. As it is further shown in FIG. 14a, a mounting plate 332 is provided to secure the guide rail 308 with screws 334 to the floor unit 12. A stop 336, which may be inserted during assembly from above into the guide rail 308 in accordance with the arrangement of the spring member 70 and the guide slide 306 within the guide rail 308, so that the guide slide 306 cannot push the guide slide 306 into an area outside of the guide rail 308 is provided so that the spring member 70 cannot pass the stop 336 in the guide direction FR and the stop 336 blocks the opening 328 at least partially.

FIG. 14b relates to an exploded view of the pivot lever assembly 300. The pivot lever arms 302, 304 are firmly coupled with each other via a web 338, so that the pivot lever assembly 300 substantially has a U-shaped form. At each of the pivot lever arms 302, 304, a castor 340 for unwinding is provided at the guide slide 306 when pivoting the guide member 14 relative to the floor unit 12 about the first pivot axis A at the free end 312. A guide receptacle 342 is further provided to attach the pivot lever assembly 300 at the connecting member 22. It has openings to accommodate the axis pins 344 for pivoting the assembly of the pivot lever assembly 300 about the third pivot axis C on the guide receptacle 342.

If the pivot lever assembly 300 is in the activated position and if the guide member 14 relative to the floor unit 12 is pivoted about the first pivot axis A starting from the neutral position and in a backward direction, the pivot lever assembly 300 engages with the guide slide 306 and pushes against it. In turn, the guide slide 306 is shifted along the guide direction FR relative to and within the guide rail 308, in particular in a backward direction. Thus, the spring member 70 is compressed, wherein an increase in the spring force generated occurs with increasing shifting or compression of the spring member 70. Apart from the degree of compression of the spring member, the amount of the spring force created depends on the spring constant of the spring member 70, wherein, in turn, the pressing effect or force applied to the pivot lever assembly 300 and thus acting on the floor unit 12 and the guide member 14, in particular the supporting or counteracting effect is thus adjustable by a suitable choice of the spring member 70 as well. If the spring member 70 is supposed to be deactivated, the pivot lever assembly 300 is pivoted about the third pivot axis C into the deactivated position, so that it rests against the guide receptacle 342. It may be provided that the pivot lever assembly 300 is, for example, detachably latchable with the guide receptacle 342. In the deactivated position of the pivot lever assembly 300, the guide member 14 may be pivoted without support or counteracting the spring member 70 relative to the floor unit 12. Since the pivot lever assembly 300 only rests against the guide slide 306 when pivoting the guide member 14 relative to the floor unit 12 about the first pivot axis A in a backward direction, in particular starting form the neutral position, in turn, the movement of the guide member 14 relative to the floor unit 12 about the pivot axis A in a forward direction is not affected by the force exerted by the spring member 70. The length of the pivot lever assembly 300 and/or the position of the guide slide 306 on the floor unit 12 may of course vary or may be varied by the operator so that the supporting or counteracting effect occurs starting from a predetermined or predeterminable swivel angle about the first pivot axis A in a backward direction.

Instead of an embodiment with the pivot lever assembly 300, the guide slide 306 and the guide rail 308, it may also be provided that the spring member 70 is, similarly to the pivot lever assembly 300, disposed at the joint assembly 16 or the guide member 14 or the floor unit 12 and is thus pivotable about the third pivot axis C or according to any other pivot form between a corresponding activated position and a corresponding deactivated position.

Optionally, it may be provided that the guide slide 306 is latchable on the guide rail 308. Thus, a lock mechanism for locking the actuation of the spring member 70 may be provided. Interlocking may be achieved, for example, by providing an actuable clamping jaw, which, upon actuation, affects the guide slide 306 and/or the guide rail 308.

Overall, the present invention helps to achieve that pivoting a guide member 14 about one or both of the pivot axes A and B may be configured to be supported by the spring force in such a way that the user is supported to a greater or lesser extent depending on the respective swivel angle, meaning that depending on the respective swivel angle, the weight force of the guide member 14 via the respective spring member is supported to a greater or lesser extent so that the user does not have to carry it or only has to carry it partially. Thus, the floor cleaning device according to the invention may be controlled particularly easy and offers ergonomic benefits.

1. A floor treatment device, comprising:
a floor unit;
at least a tool which is assigned to the floor unit and which contacts a floor surface in an operating state;
a guide member for guiding the floor treatment device by a user; and
a joint assembly with at least two pivot axes, wherein the joint assembly is configured to pivot the guide member relative to the floor unit about a first pivot axis and to pivot the guide member relative to the floor unit about a second pivot axis that is different than the first pivot axis relative to the floor unit,
wherein at least a spring member for creating a spring force between the floor unit and the guide member is assigned to the joint assembly, and
wherein the spring force of the spring member supports or counteracts a movement of the guide member relative to the floor unit when the guide member is pivoted about the first and/or the second pivot axis relative to the floor unit.

2. The floor treatment device of claim 1, wherein the first pivot axis is substantially parallel to the floor surface.

3. The floor treatment device of claim 1, wherein the second pivot axis is transverse or skew to the first pivot axis.

4. The floor treatment device of any one of the preceding claim 1, wherein the joint assembly has a first pivot joint defining the first pivot axis.

5. The floor treatment device of claim 1, wherein the joint assembly has a second pivot joint defining the second pivot axis.

6. The floor treatment device of claim 5, wherein the first and/or the second pivot joint has a neutral position.

7. The floor Fleer treatment device of claim 6, wherein the guide member is disposed in such a way about the first pivot axis in the neutral position of the first pivot joint that a longitudinal axis of the guide member with a vertical axis (Z), which extends perpendicular to the floor unit and perpendicular to the first pivot axis, includes an angle that ranges between 15 and 30°.

8. The floor treatment device of claim 6 wherein the guide member is disposed about the second pivot axis in such a way in the neutral position of the second pivot joint that the longitudinal axis of the guide member with the first pivot axis includes an angle of approximately 90°.

9. The floor treatment device of claim 6, wherein the at least one spring member keeps the guide member in the neutral position via the spring force.

10. The floor treatment device of claim 9, wherein when pivoting the guide member out of the neutral position into at least one pivot direction of at least one spring member, a spring force, which initially increases via a first angular range regarding the first and/or the second pivot axis and which either remains constant or decreases when exceeding the first angular range, is applied.

11. The floor treatment device of claim 1, wherein the spring force of the at least one spring member is substantially constant while the guide member is pivoted about the first or the second pivot axis.

12. The floor treatment device of claim 1, wherein the spring force of the at least one spring member is substantially variable while the guide member is pivoted about the first or the second pivot axis.

13. The floor treatment device of claim 1, wherein a single mutual spring member is assigned to the first and second pivot axis.

14. The floor treatment device of claim 1, wherein at least a separate spring member is assigned to each of the first and second pivot axes.

15. The floor treatment device of claim 14, wherein the spring members have the same or different spring characteristics.

16. The floor treatment device of claim 5, wherein the spring member has at least one profile body with a slide section as well as a spring element, wherein the slide section determines a non-linear, variable spring force by amount in interaction with the spring effect of the spring element when pivoting the guide member via the second pivot joint about the second pivot axis relative to the floor unit.

17. The floor treatment device of claim 16, wherein the at least one profile body is attached to the guide member and is pivotable about the first and/or second pivot axis with the guide member.

18. The floor treatment device of claim 17, wherein the at least one profile body is attached directly or indirectly to the floor unit in such a way that it is not pivoted when the guide member is pivoted about the first or second pivot axis-relative to the floor unit opposite the guide member.

19. The floor treatment device of claim 17, wherein the at least one profile body is attached directly or indirectly to the joint assembly in such a way that it is not pivoted when the guide member is pivoted about the second pivot axis relative to the floor unit opposite the guide member, but that it is pivoted when the guide member is pivoted about the first pivot axis relative to the floor unit.

20. The floor treatment device of any one of claim 16, wherein the at least one profile body has a concave or convex slide section or a slide section formed of concave and convex sections.

21. The floor Fleer treatment device of claim 20, wherein the concave slide section has a substantially central apex region to define a neutral position of the first and/or the second pivot joint.

22. The floor Fleer treatment device of claim 16, wherein the at least one profile body comprises a double convex slide section having two convex slide section segments that are connected via a substantially central concave connecting area to define a neutral position of the first and/or the second pivot joint.

23. The floor treatment device of claim 16, wherein a rolling element or slide element concurring with the slide section is assigned to the spring member, wherein the rolling element or slide element is biased onto the slide section via the spring element and rolls or slides on the slide section when the guide member is pivoted relative to the floor unit about the first and/or second pivot axis.

24. The floor treatment device of claim 1, wherein the at least one spring member comprises a compression spring, a tension spring or a spring-damper member.

25. The floor treatment device of claim 1, wherein the at least one spring member may be activated and deactivated.

26. The floor treatment device of claim 1, characterized in that wherein the at least one spring member is adjustable in its pretention so that the support effect of the at least one spring member may be adjustable by the user if necessary.
